(19) United States
(12) Patent Application Publication
(10) Pub. No.: US 2014/0020515 A1
(43) Pub. Date: Jan. 23, 2014

(54) Tensioning device for extending a threaded bolt

(71) Applicants: Jörg Hohmann, Meschede (DE); Frank Hohmann, Warstein (DE)

(72) Inventors: Jörg Hohmann, Meschede (DE); Frank Hohmann, Warstein (DE)

(21) Appl. No.: 13/941,581

(22) Filed: Jul. 15, 2013

(30) Foreign Application Priority Data
Jul. 18, 2012 (DE) 10 2012 106 503.9

(51) Int. Cl. B23P 19/06

(52) U.S. Cl. CPC B23P 19/067
USPC 81/57.38

(57) ABSTRACT

A tensioning device for extending a threaded bolt by tensioning the threaded end section thereof is connectable to a hydraulic supply. The tensioning device has a supporting tube surrounding the threaded end section. A cylinder is arranged in continuation of the supporting tube and s piston is arranged in the cylinder and movable in longitudinal direction of the cylinder. An exchange socket is screwable to the threaded end section and configured to be carried along axially by the piston. A pin is movably arranged in the longitudinal direction and has a pin body with a first pin end supported in the longitudinal direction against the threaded end section of the threaded bolt. A sensing device senses a position of the pin in the longitudinal direction. An evaluation and control unit connected to the sensing device is acting on the hydraulic supply to enable the hydraulic supply.

### BACKGROUND OF THE INVENTION

The invention relates to a tensioning device for extending a threaded bolt by way of tension on the threaded end section thereof, having a supporting tube surrounding the threaded end section, a cylinder which is arranged in continuation of the supporting tube and has at least one piston that is movable in the longitudinal direction therein and is connectable to a hydraulic supply, an exchange socket which is screwable to the threaded end section and is configured such that it can be carried along axially by the piston, and a pin which is arranged so as to be movable in the longitudinal direction and the pin end of which is supportable in the longitudinal direction against that end of the threaded bolt that has the threaded end section.

A hydraulically operating bolt tensioning device having these features is known from U.S. 2011/0271798 A1. The tensioning device has measures for monitoring the thread projection, i.e. the length of the threaded end section, gripped by the exchange socket, of the threaded bolt. To this end, the exchange socket is provided with a longitudinal channel in which a measuring rod is fitted in a longitudinally movable manner. The lower end of said measuring rod is supported in the longitudinal direction against the end face of the threaded bolt to be tensioned. At its other end, the measuring rod is provided with coloured markings, by way of which it is possible to read, with respect to the exchange socket, whether the thread projection, i.e. the length of the threaded section gripped by the exchange socket, is large enough for the tensioning process. With the measuring rod according to U.S. 2011/0271798 A1 given appropriate attention on the part of the machine operator, it is possible for the thread projection actually present to be assessed. However, if the necessary attention is absent, operating errors cannot be ruled out.

The invention is based on the object, in the case of a generic tensioning device for extending a threaded bolt, of providing increased security against a thread engagement length that is insufficient for the extension process.

### SUMMARY OF THE INVENTION

In order to achieve this object, a generic tensioning device for extending a threaded bolt by way of tension on the threaded section thereof is characterized by
a means for sensing the position of the pin in the longitudinal direction,
an evaluation and control unit which is connected to the sensing means and by way of which the hydraulic supply can be enabled.

With such a tensioning device, a prerequisite prior to starting each bolt tensioning process is that a sufficient actual length of the thread engagement is objectively present between the exchange socket and the end of the threaded bolt. To this end, according to the invention, a means is present which is able to sense the position of the pin in the longitudinal direction. An evaluation and control unit arranged downstream in the signal flow compares whether the detected longitudinal position of the pin corresponds to an internally predefined minimum position value, and therefore it is possible objectively to proceed from a sufficient thread engagement length. Only if this is the case does the evaluation and control unit in principle enable the hydraulic supply such that only then is the latter activatable for building up the hydraulic pressure in the piston chamber. As a result, increased security is achieved in that the possibility is ruled out that, on account for example of a lack of attention, the tensioning device is set into operation in the event of an insufficient thread engagement length. Rather, setting into operation is only possible after the evaluation and control unit has in principle enabled the hydraulic supply.

According to one configuration of the tensioning device, a wireless signal path may be a constituent part of the evaluation and control unit, having a transmitting module arranged on the cylinder and a receiving module arranged in the region of the hydraulic supply. This configuration takes account of the circumstance that, in the case of generic tensioning devices, the hydraulic supply, including the valves controlling the build-up of pressure, is connected to the actual tensioning cylinder by a flexible pressure line, and thus there is a certain distance between the tensioning cylinder and the hydraulic supply. In order to bridge this distance and to avoid additional lines, signal transmission by means of a transmitting and receiving module is advantageous.

According to a further configuration of the tensioning device, inductively operating means for sensing the position of the pin are provided.

In a further configuration, it is proposed that the sensing means are arranged in the region of the other pin end, i.e. that end of the pin that is remote from the threaded bolt.

Preferably, the sensing means are configured to sense the longitudinal position of he pin with respect to the exchange socket.

A further configuration is characterized by a display unit, arranged on the cylinder, for displaying the position of the pin in the longitudinal direction. Preferably, the display unit is configured to display the longitudinal position of the pin with respect to the exchange socket, preferably in the form of an optical display.

A further configuration provides that the pin has a signal-emitting or signal-triggering section on which the pin changes its diameter. For example, the pin can be configured in a conically tapering manner at this end, this being able to be felt by a measuring pin mounted transversely thereto.

For a compact structure, it is proposed that the pin is arranged in a longitudinal guide in the exchange socket. This has the additional advantage that when the exchange socket is replaced, the pin is also exchanged at the same time. This is because the two are matched to one another in terms of their geometric dimensions and to the threaded bolt to be tensioned.

According to a further configuration, the pin is formed in a radially widened manner at its lower pin end compared with the pin cross section. As a result of this radial widened section, the contact between the pin and the bolt to be tensioned always takes place in a single plane, specifically in the plane of the end face of the bolt and thus in that plane as far as which the external thread, available for the tensioning process, of the bolt usually extends, This measure makes it possible to assess the actual length of the thread engagement even in cases in which imprecise evaluation results would otherwise arise in the evaluation and control unit, for instance because the bolt has a central thread depression and the narrow end of the pin is supported in the latter and not on the actual end face of the threaded bolt.

In a further configuration, it is proposed that the widened section is provided, opposite the end face of the threaded bolt, with an identification element which operates as a sensor and senses at least one feature formed on the end face.

### BRIEF DESCRIPTION OF THE DRAWINGS

Further details and advantages will become apparent from the following description of an exemplary embodiment illustrated in the drawing, in which:

FIG. 1 shows, largely in a section illustration, a hydraulically operating threaded bolt tensioning device, placed on a threaded bolt secured by a nut and supported on a base;

FIG. 2 shows the threaded bolt tensioning device according to FIG. 1, but not supported on the base, with the thread engagement with the threaded bolt being too short;

FIG. 3 shows the detail designated III in FIG. 1 on an enlarged scale;

FIG. 4 shows a partial plan view of the threaded bolt tensioning device.

### DESCRIPTION OF PREFERRED EMBODIMENTS

The hydraulically operated tensioning device serves to tighten and optionally also to release highly stressed screw connections. The tensioning device has the task of applying a predetermined pre-tensioning force onto the threaded bolt 3 for a certain amount of time in the longitudinal direction of the bolt, in order to create the possibility of tightening or retightening in a torque-free manner the nut 4, screwed onto the threaded bolt 3, of the screw connection. For this purpose, an exchange socket of the tensioning device which is described in more detail in the following text is screwed onto the thread, protruding beyond the nut 4, of the threaded bolt 3 and subsequently put under hydraulic tension, as a result of which the threaded bolt 3 is extended in the longitudinal direction.

The screw-in depth of the threaded bolt is limited by the length, which is available as a bolt projection above the nut 4, of the threaded section A. The screw-in depth available should be at least the same as, and preferably 1.5 times, the thread diameter of the bolt. It is only the minimum screw-in depth that ensures that the threaded bolt 3 is not damaged by the tensioning process. If a minimum value for the length A1 of the thread engagement is not maintained, the threaded bolt end can break off.

The bolt tensioning device has a housing which consists of one or more cylinders 1, The downward continuation of the housing or the cylinders 1 in the longitudinal direction L is formed by a supporting tube 2 which is open on its underside and is supported on that base 8, usually a machine part, on which the nut 4 is also supported. A hydraulic connection, via which the tensioning device is connected to a hydraulic supply 6, is located laterally on the housing composed of the cylinders 1.

Furthermore, a gear mechanism 15 which operates through orifices in the supporting tube 2 and by way of which the nut 4 screwed onto the threaded bolt 3 can be rotated may be provided. This rotation is of course only possible when the tensioning device is in operation and therefore the nut 4 is not subjected to considerable frictional loading.

In the exemplary embodiment, the housing contains a plurality of, in this case two, hydraulic cylinders which are connected in parallel and are each connected to an external hydraulic supply 6 via a flexible, pressure-tight hydraulic line 6A connected to a hydraulic connection 7. A piston 5 is arranged in each of the cylinders 1 so as to be movable in the longitudinal direction L, said piston being sealed off in the direction of the cylinder 1. In the exemplary embodiment, these are thus a lower piston 5 and an upper piston 5, which are moreover only movable jointly. When the hydraulic supply 6 is activated, the feeding of hydraulic pressure into the working spaces of the cylinders causes the pistons 5 arranged therein to be raised. This may take place counter to the action of a compression spring 16 supported on the uppermost piston 5.

The pistons 5 are connected rigidly to an exchange socket 10 arranged centrally therein, and so the movement of the pistons 5 results in an identical movement of the exchange socket 10. The latter is designed to be exchangeable by means of suitable measures, and can thus be exchanged for an exchange socket, 10 of different geometry, whereas the piston 5 or the pistons 5 are not exchanged for other pistons.

The exchange socket 10 is composed integrally of a lower coupling section and an upper shank section. The coupling section is located inside the supporting tube 2 and has an internal thread which is screwable together with the external thread of the threaded bolt 3. The shank section of the exchange socket 10 is surrounded by the pistons 5, to which it is rigidly connected, preferably by way of a screw connection.

In order to tension the threaded bolt, the exchange socket 10 is screwed onto the threaded end section A of the threaded bolt. By feeding hydraulic pressure, the pistons 5 are raised, carrying along the exchange socket 10, as a result of which longitudinal extension of the threaded bolt 3 occurs, Associated with this is a loss of friction on the underside of the nut 4, such that the latter can be rotated on the thread of the bolt, i.e. can be retightened.

It is important for the tensioning operation that the screw-in depth, made available by the length of the threaded end section A, of the threaded bolt 3 is utilized fully by the corresponding internal thread of the exchange socket 10, and a sufficient length A1 of the thread engagement is reliably achieved.

In order to monitor the thread engagement length, a pin 20 is located centrally in a longitudinal bore in the exchange socket 10. Said pin 20 is provided with a collar or a widened section 21, against which a spring 21A, which is supported on the other side opposite the exchange socket 10, is supported. In this way, the pin 20, which is longitudinally movable in a longitudinal guide 17 in the exchange socket, is always acted on by a force, which pushes it slightly downward, i.e. in the direction of the threaded bolt 3,

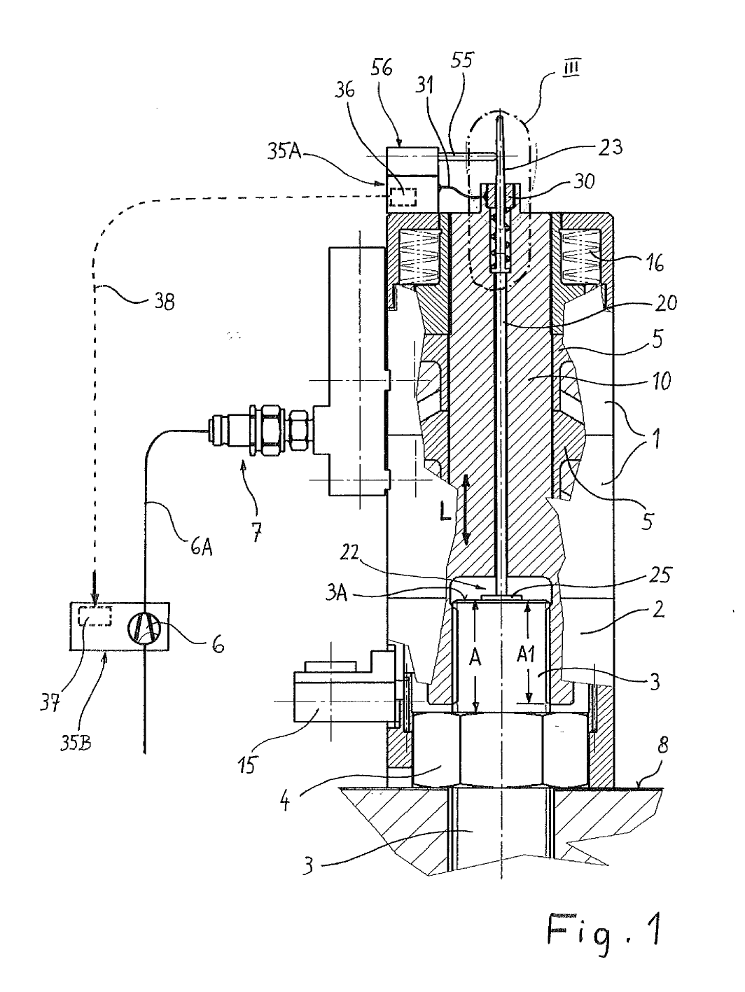

At its lower end 22, the pin 20 is supported axially against the end face 3A of the threaded bolt 3. The other end 23 of the pin 20 is located in the region of the upper part of the tensioning device. There, technical measures, which are described in more detail in the following text, are taken in order to sense the longitudinal position of the pin end 23 and thus the position of the pin 20 in the longitudinal direction L. From this longitudinal position, it is possible to deduce the height at which the lower pin end 22 is located, thereby in turn allowing a direct conclusion to be drawn about the length of the thread engagement A1 at the threaded end section A. Specifically, if, in the situation according to FIG. 1, the length A1 of the thread engagement were less than illustrated, the pin 20 would be lowered further, and this is detectable from the position of the upper pin end 23 in relation to the exchange socket 10 or in relation to the cylinder.

In order to detect the height position of the pin 20, sensing means 30 for sensing the longitudinal position of the pin with respect to the exchange socket 10 are arranged in the region of the pin end 23. These means 30 are configured to sense the position of the pin 20, e.g. in an inductive manner. The electric position signals pass to an evaluation and control unit 35A, 356 via a signal line 31.

The evaluation and control unit 35A can be arranged at the top on the housing of the tensioning device. However, an arrangement at some other location is also possible, e.g. the evaluation and control unit 356 can, as likewise illustrated in FIG. 1, be arranged in the region or as a constituent part of the hydraulic supply 6.

The sensing means 30 reproduced on an enlarged scale in FIG. 3 operates in an electric-inductive manner. It is fitted firmly into a corresponding recess in the top of the exchange socket 10, The longitudinal position of the pin 20 with respect to the exchange socket 10 is sensed by the sensing means 30.

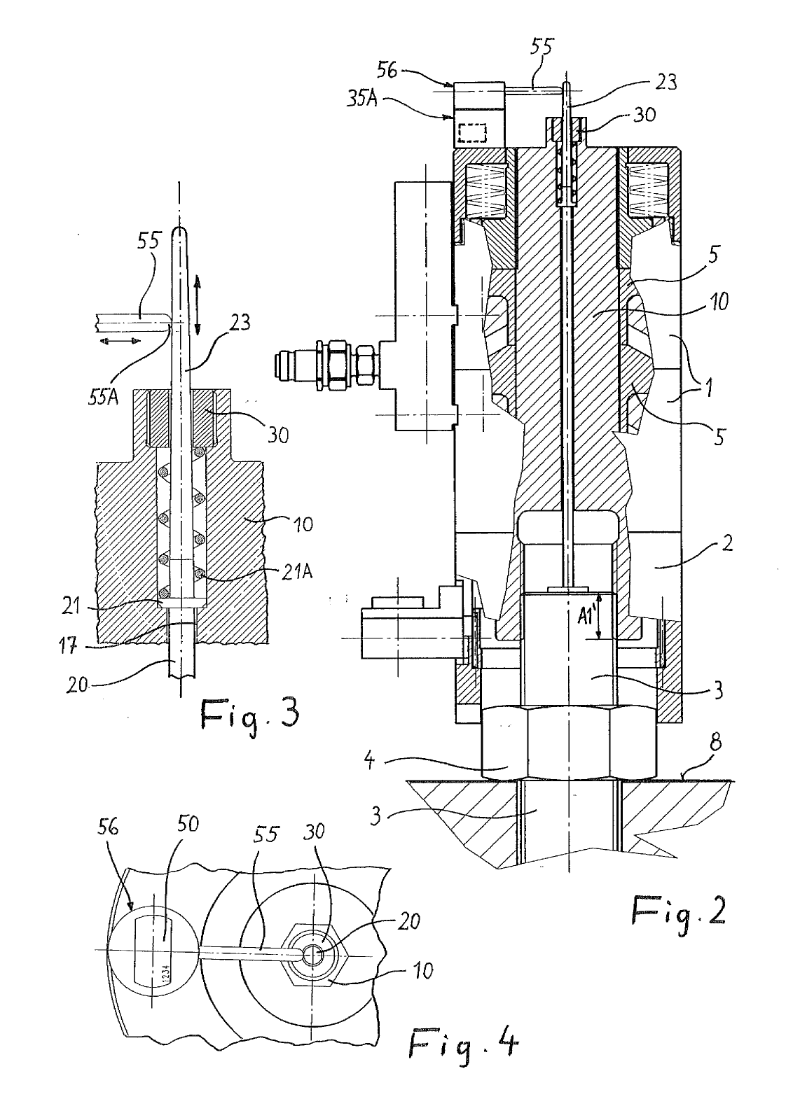

The inductively sensed position signals pass via the signal line 31 to the evaluation and control unit 35A or 358. A comparison of the sensed longitudinal position of the pin 20 with an internally predefined value and in particular a minimum value takes place therein, If this value is dropped below, as is illustrated by way of example with the value A1 in FIG. 2, a too short length A1′ of the thread engagement is internally assumed. In this case (FIG. 2), the evaluation and control unit 35A or 35B does not enable the hydraulic supply 6 and so it is not possible for a hydraulic pressure to build up with respect to the piston 5. An operating error on account of a lack of concentration in reading off displayed values or dimensions is ruled out.

It is not necessary to arrange the evaluation and control unit directly on the cylinder 1. According to FIG. 1, the evaluation and control unit 358 can also be located in the region of the valve-controlled hydraulic supply 6 from which the flexible pressure line 6A leads to the hydraulic connection 7 on the device. If the evaluation and control unit 35B is located at or in the region of the hydraulic supply 6, a wireless signal path 38 from the sensing means 30 is expedient. To this end, a transmitting module 36 is arranged on the cylinder 1 and the corresponding receiving module 37 is arranged in the region of the hydraulic supply.

The lower pin end 22 can be radially widened compared with the rest of the pin cross section. For this purpose, the lower pin end is in the form of a disc 25, the radial width of which is greater than the remaining cross section of the pin 20. The widened section 25 formed in this way should not be larger than the size of the end face 3A of the threaded bolt. As a result of the radial widened section 25, the contact between the pin and the bolt 3 to be tensioned always takes place in a single plane, specifically in the plane of the end face 3A of the bolt. This makes it possible to assess the length A1 of the actually engaged thread projection even in cases in which imprecise evaluation results would otherwise arise, for instance because the threaded bolt 3 has a central thread depression. Specifically, if the pin 20 were to end in a slender manner at the bottom, it would be supported in this thread depression and not on that end face 3A of the threaded bolt 3, up to the height of which the thread of the threaded bolt 3 frequently extends. Therefore, the radial width of the widened section 25 should be at least the same size as the depression.

An identification element may be located in the disc 25, opposite the end face 3A of the threaded bolt 3. In order to accommodate said identification element, the disc 25 may be provided with a correspondingly dimensioned recess. The identification element is configured to sense at least one feature formed or arranged on the end face 3A of the threaded bolt. This feature may be a marking on the bolt or the screw connection, e.g. a barcode, or the grade of the material of which the threaded bolt consists, However, other markings which are located in the region of the end face 3A may also be detectable by the identification element. The sensor signal of the identification element passes via a signal cable to an evaluation unit This may be the same evaluation and control unit 35A or 35B to which the signals from the means 30 for sensing the longitudinal position of the pin 20 also pass. In order to accommodate the signal cable, the pin 20, which is itself axially guided in the longitudinal guide 17 of the exchange socket 10, is provided with a longitudinal channel preferably arranged on the pin axis. The signal cable coming from the identification element is in this way guided along the pin 20. In the evaluation and control unit 35A, the signals coming from the identification element in the disc 25 are also evaluated in a suitable manner, and if appropriate processed further. Electronic documentation of the data collected by the identification element can also take place in the evaluation and control unit 35A, 358 as part of the documentation of the tensioning process.

The other pin end, that is to say the upper pin end 23, is in the form of a signal-emitting or signal-triggering pin section. The pin end 23 does not have a constant thickness here, but rather its thickness, or its diameter, changes with length, for instance by way of a narrowing, reproduced in FIG. 3, of the pin 20 towards its end. If the pin 20 changes its position in the longitudinal direction L, a measuring pin 55 which is mounted transversely to the pin axis and is supported with its one end 55A against the pin end 23, moves in a corresponding manner transversely to the pin 20.

In this variant, the position of the pin 20 is not mechanically sensed directly, but rather the position of the additional measuring pin 55. The latter is connected at its other end, within a sensor housing 56 fastened to the cylinder 1, to a displacement measuring device having a display unit 50 (FIG. 4). The display unit 50 reproduces the mechanically sensed height position of the pin 20 optically or by way of numerical values, this allowing the machine operator an additional means for monitoring of the thread engagement length.

The specification incorporates by reference the entire disclosure of German priority document 10 2012 106 503.9 having a filing date of Jul. 18, 2012.

While specific embodiments of the invention have been shown and described in detail to illustrate the inventive principles, it will be understood that the invention may be embodied otherwise without departing from such principles.

### LIST OF REFERENCE CHARACTERS

1 cylinder
2 supporting tube
3 threaded bolt
3A end face of the threaded bolt
3B depression
4 nut
5 piston
6 hydraulic supply
6A pressure line
7 hydraulic connection
8 base
10 exchange socket
15 gear mechanism
16 compression spring
17 longitudinal guide
20 pin
21 widened section
21A spring
22 pin end
23 pin end
25 widened section, disc
30 means for sensing the longitudinal position
31 signal line
35A evaluation and control unit
35B evaluation and control unit
36 transmitting module
37 receiving module
38 signal path
50 display unit
55 measuring pin
55A pin end
56 sensor housing
A threaded end section
A1 length of thread engagement
A1′ length of thread engagement
L longitudinal direction

What is claimed is;

1. A tensioning device for extending a threaded bolt by tensioning the threaded end section thereof, wherein the tensioning device is connectable to a hydraulic supply, the tensioning device having a supporting tube surrounding the threaded end section; a cylinder arranged in continuation of the supporting tube and at least one piston arranged in the cylinder and movable in a longitudinal direction of the cylinder; an exchange socket screwable to the threaded end section and configured to be carried along axially by the piston; and a pin arranged so as to be movable in the longitudinal direction and having a pin body with a first pin end supportable in the longitudinal direction against the end of the threaded bolt that has the threaded end section; sensing means for sensing a position of the pin in the longitudinal direction; an evaluation and control unit connected to the sensing means and acting on the hydraulic supply to enable the hydraulic supply.

2. The tensioning device according to claim 1, wherein the evaluation and control unit has a wireless signal path comprising a transmitting module arranged on the cylinder and a receiving module arranged in the region of the hydraulic supply.

3. The tensioning device according to claim 1, wherein the sensing means comprise an inductively operating means for sensing the position of the pin.

4. The tensioning device according to claim 1, wherein the sensing means are arranged in the region of a second pin end of the pin, the second pin end opposite the first pin end.

5. The tensioning device according to claim 1, wherein the sensing means are configured to sense the longitudinal position of the pin relative the exchange socket.

6. The tensioning device according to claim 1, further comprising a display unit, arranged on the cylinder, wherein the position of the pin in the longitudinal direction is displayed on the display unit.

7. The tensioning device according to claim 6. wherein the pin has a signal-emitting section or signal-triggering section wherein the pin has a change in diameter.

8. The tensioning device according to claim 1, wherein the exchange socket has a longitudinal guide and the pin is arranged in the longitudinal guide.

9. The tensioning device according to claim 1, wherein the first pin end has a radially widened section that has a radial cross-section that is wider than a radial pin cross-section of the pin body.

10. The tensioning device according to claim 1, wherein the widened section is provided, opposite the end face of the threaded bolt, with an identification element which operates as a sensor and senses at least one feature formed on the end face.
